(19) United States
(12) Patent Application Publication
(10) Pub. No.: US 2005/0196564 A1
(43) Pub. Date: Sep. 8, 2005

(54) Tubular strip for leisure chair

(75) Inventors: Teng Yi Wang, Taipei (TW); Chang I. Wu, Taipei (TW)

Correspondence Address: TROXELL LAW OFFICE PLLC, Suite 1404, 5205 Leesburg Pike, Falls Church, VA, 22041, US

(73) Assignee: Shen-Tai Industry Co., Ltd.

(21) Appl. No.: 10/791,742

(22) Filed: Mar. 4, 2004

(51) Int. Cl. B32B 1/08

(52) U.S. Cl. 428/35.2; 428/36.9

(57) ABSTRACT

A tubular strip for leisure chair is made of a specific pliable polyvinyl chloride (PVC) material by way of injection molding, so that the tubular strip has a reduced wall thickness with a plurality of spaced reinforcing ribs integrally molded on an outer surface of the tubular strip to provide a common force-bearing structure.

### FIELD OF THE INVENTION

The present invention relates to a tubular strip for leisure chair, and more particularly to a tubular strip that is molded using largely reduced quantity of polyvinyl chloride (PVC) material while provides sufficient structural strength required for use on a leisure chair.

### BACKGROUND OF THE INVENTION

Due to its wide applications, polyvinyl chloride (PVC) material has become one of the most important raw materials in current plastic industry. PVC is also appreciated for it low price, good workability, and noncombustible property. Plasticizer and fillers may be added for PVC material to have different hardness and be used in making products such as plastic tubes, pipes, hoses and the like.

In recent years, the demand for PVC in the world constantly increases, and is as high as 25 million metric tons in 1999. The demand for PVC keeps growing at a rate approximate to 4.5% each year. Among others, PVC demand in Asian countries has the highest annual rate of growth of 8%.

Calcium carbide process is currently a major way for producing PVC though it disadvantageously consumes high energy and possibly results in environment pollution. In recent years, the shortage of coal in the international market due to the high demand for PVC in Asia, and the current policy of restricted supply of power in China, one of the largest PVC production centers in the world, have caused further reduction in productivity of PVC produced by the calcium carbide process, as well as constant rise in PVC price in Far East. In view that the shortage of coal in the international market and the restricted power supply policy in China will continue, it is expected the market demand and the price for PVC would still keep rising at least in the near future.

The largely increased PVC price in turn results in increased manufacturing cost in firms that use PVC as a major material in their products. For example, as illustrated in FIG. 1, a deck chair 10 typically includes a seat 11, a back 12, and a footrest 13, a large part of these areas are usually formed using a plurality of tubular strips 14 parallelly and continuously arranged and stretched over frames of the deck chair 10. The tubular strips 14 are then firmly set in place on the deck chair 10 by welding at predetermined positions to form welded seams 15.

FIGS. 2 and 3 are perspective and cross-sectional views, respectively, of the conventional tubular strip 14. For the tubular strip 14 to have required structural strength for bearing a force applied thereon, the tubular strip 14 must have a specific wall thickness T. Each deck chair 10 would require at least several decades of tubular strips 14, each being in the length no less than one meter. Therefore, a significantly large quantity of PVC material is required for producing one such deck chair. Under this condition, the recently constantly increased PVC price inevitably becomes a heavy burden of the manufacturers of such deck chair with PVC strip seat, back and footrest.

### SUMMARY OF THE INVENTION

A primary object of the present invention is to provide a tubular strip that provides a structural strength required for forming the seat, the back, and the footrest of a leisure chair but can be made with largely reduced quantity of PVC material to effectively reduce the manufacturing cost of such leisure chair.

Another object of the present invention is to provide an improved tubular strip for leisure chair; so that the seat, the back, and the footrest of the leisure chair formed using the tubular strip of the present invention have good air ventilation for comfortable contact with a user's skin.

To achieve the above and other objects, the tubular strip for leisure chair according to the present invention is made of a predetermined pliable polyvinyl chloride (PVC) material by way of injection molding, so that the tubular strip has a reduced wall thickness with a plurality of spaced reinforcing ribs integrally molded on an outer surface of the tubular strip to provide a common force-bearing structure.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a deck chair with its back, seat, and footrest formed with tubular strips;

FIG. 2 is a fragmentary perspective view of a conventional tubular strip used in the deck chair of FIG. 1;

FIG. 3 is a cross-sectional view of FIG. 2;

FIG. 4 is a fragmentary perspective view of an externally ribbed tubular strip for leisure chair according to a preferred embodiment of the present invention;

FIG. 5 is a cross-sectional view of FIG. 4; and

FIG. 6 is a fragmentary cross-sectional view of a plurality of tubular strips of the present invention in a parallelly positioned and tightly stretched state.

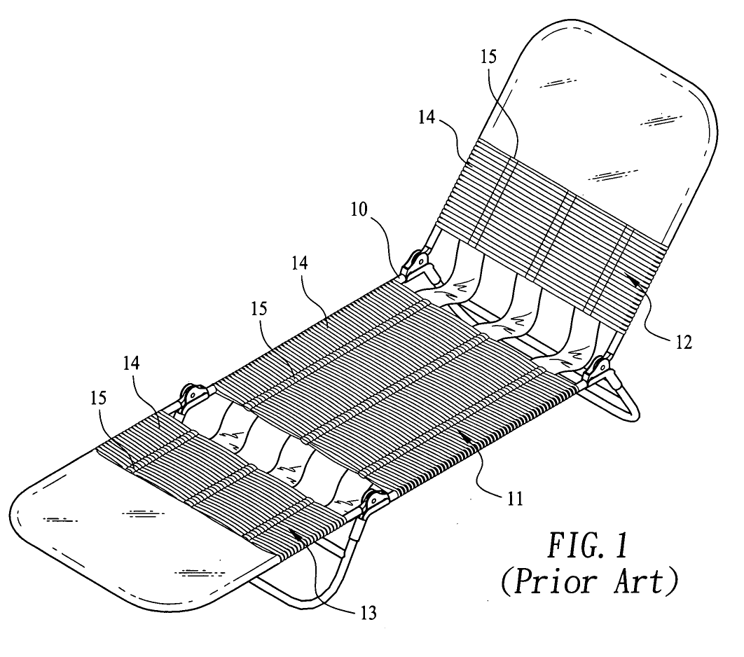

### DETAILED DESCRIPTION OF THE PREFERRED EMBODIMENTS

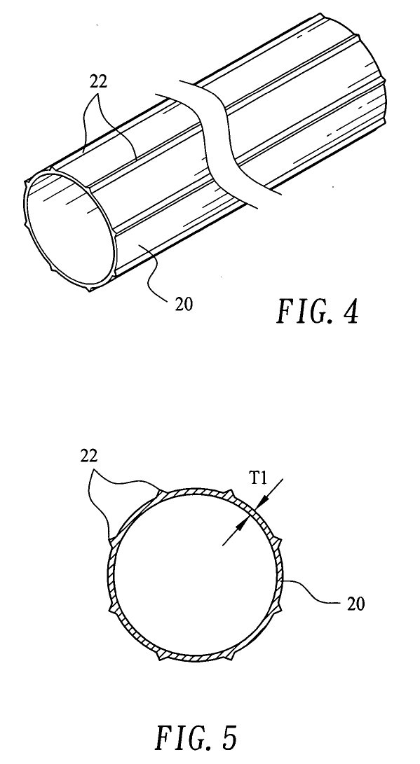

Please refer to FIGS. 4 and 5 that are fragmentary perspective and cross-sectional views, respectively, of a tubular strip 20 according to a preferred embodiment of the present invention for use on a leisure chair.

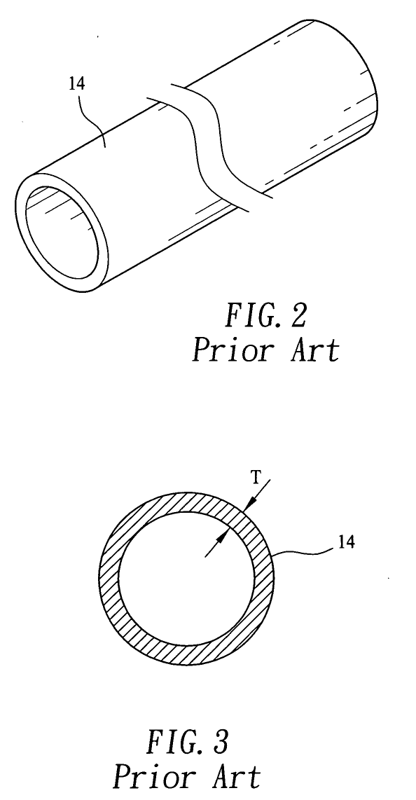

The tubular strip 20 is in the form of a hollow tube made of a specific pliable PVC material, and has a wall thickness Ti that is significantly reduced as compared to the wall thickness T of the conventional tubular strip 14 shown in FIGS. 2 and 3. In the illustrated embodiment, the wall thickness T1 of the tubular strip 20 for leisure chair is about one third (⅓) to one half (½) of the wall thickness T of the conventional tubular strip 14.

The tubular strip 20 of the present invention is characterized by a plurality of axially extended reinforcing ribs 22 circumferentially spaced on an outer surface of the tubular strip 20. Though not necessary, the reinforcing ribs 22 in the illustrated embodiment are angularly arranged on the outer surface of the tubular strip 20 at equidistance. For example, the reinforcing ribs 22 may be spaced from one another by 45 degrees on the tubular strip 20. However, it is understood the present invention is not limited to the above design. That is, for the sake of saving material, the reinforcing ribs 22 on the outer surface of the tubular strip 20 may be in the number and at angular positions determined according to actual need in forming differently designed leisure chairs.

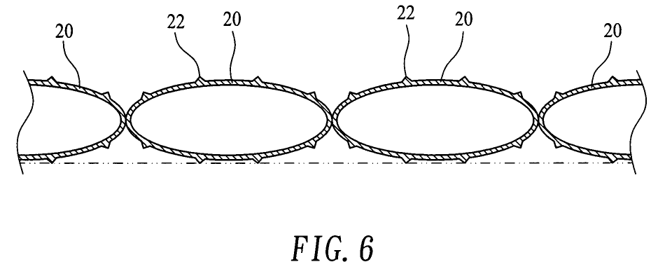

Please refer to FIG. 6. When a plurality of tubular strips 20 of the present invention are parallelly positioned and tightly stretched over the leisure chair to form the back, the seat, and the footrest, the tubular strips 20 subject to the stretch have each a hollow elliptic cross section that provides relatively larger force-bearing surface area. The parallelly positioned and tightly stretched tubular strips 20 are then welded at predetermined positions to firmly fix on frames of the leisure chair. When the tubular strips 20 that are welded together and firmly fixed to the frames of the leisure chair are subjected to a force, it is the outer surfaces of the tubular strips 20 and the spaced reinforcing ribs 22 provided thereon that together provides the tubular strips 20 with sufficient structural strength to bear the force applied thereto.

The tubular strip for leisure chair according to the present invention can be advantageously mass-produced using PVC material by way of injection molding and in procedures exactly the same as the existing ones with slightly modified molds.

Since the tubular strip 20 of the present invention has largely reduced wall thickness and sufficient structural strength, it enables the leisure chair that uses the tubular strips 20 to cover most areas of the back, the seat, and the footrest of the leisure chair to be manufactured with largely reduced quantity of PVC material and accordingly, at effectively lowered manufacturing cost without being affected by the constantly rising price in the international PVC cash market. Moreover, with the reinforcing ribs 22, the outer surface of the tubular strip 20 provides better air ventilation for forming a more comfortable leisure chair.

The present invention has been described with a preferred embodiment thereof and it is understood that many changes and modifications in the described embodiment can be carried out without departing from the scope and the spirit of the invention that is to be limited only by the appended claims.

1. A tubular strip for leisure chair, comprising a hollow tubular body made of a specific pliable PVC material by way of injection molding and having a reduced wall thickness as compared to general tubular strips, and a plurality of axially extended reinforcing ribs integrally molded on an outer surface of said tubular body.

2. The tubular strip for leisure chair as claimed in claim 1, wherein said reinforcing ribs are circumferentially equally spaced on said outer surface of said tubular body.
